(19) United States
(12) Patent Application Publication
(10) Pub. No.: US 2018/0066538 A1
(43) Pub. Date: Mar. 8, 2018

(54) GAS TURBINE ENGINE

(71) Applicant: ROLLS-ROYCE plc, London (GB)

(72) Inventors: Steven A. RADOMSKI, Nottingham (GB); Dale E EVANS, Derby (GB)

(73) Assignee: ROLLS-ROYCE plc, London (GB)

(21) Appl. No.: 15/667,324

(22) Filed: Aug. 2, 2017

(30) Foreign Application Priority Data
Sep. 2, 2016 (GB) 1614888.4

(51) Int. Cl. F01D 25/10; F01D 9/04; F01D 25/02

(52) U.S. Cl. CPC F01D 25/10; F01D 9/041; F01D 25/02; F05D 2220/32; F05D 2240/121; F05D 2300/605; F05D 2260/22141; F05D 2260/208; F05D 2260/98; F05D 2260/40311; F05D 2300/43

(57) ABSTRACT

A gas turbine engine comprising a stator, wherein the stator comprises laminated oscillating heat pipes.

### TECHNICAL FIELD

The present disclosure concerns a gas turbine engine and/or a component having a de-icing arrangement.

### BACKGROUND

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

Engine section stator (ESS) vanes are provided at the inlet to the engine core. These vanes guide air flow entering the core. The vanes may be structural i.e. be provided to support load between an inner and an outer casing member, or non-structural. When the vanes are non-structural, a high number of thin vanes can improve noise and efficiency whilst maintaining flow capacity.

ESS vanes can experience ice build-up, and when there are a high number of vanes there is also a risk of ice bridging. If the gas turbine engine has a geared fan, the fan can rotate at a slower speed than fans that aren't geared, which can further increase ice build-up on the ESS vanes due to a reduced temperature rise in the fan hub. Ice build-up is a problem because it can shed into the core of the engine and potentially lead to damage of engine components.

### SUMMARY

According to an aspect there is provided a gas turbine engine comprising a stator. The stator comprises laminated oscillating heat pipes.

The oscillating heat pipes can be arranged so that they oscillate between a heat source in the gas turbine engine (e.g. oil of a gearbox or bleed air flow) and a portion of the stator that requires de-icing. Heat flow to the portion of the stator that requires de-icing can prevent or limit ice formation on the stator.

The oscillating heat pipes may be of varying lengths.

A portion of one oscillating heat pipe may provide insulation to a portion of an adjacent oscillating heat pipe.

A portion of each oscillating heat pipe may be substantially aligned with a portion of at least one other oscillating heat pipe.

One or more of the oscillating heat pipes may bend so that a portion of the oscillating heat pipe is aligned with a portion of one or more of the other oscillating heat pipes.

One or more of the oscillating heat pipes may have a first portion and a second portion extending in a spanwise direction of the stator, the first portion extending in a different plane to the second portion. The one or more oscillating heat pipes may have a transition region connecting the first portion to the second portion.

The oscillating heat pipes may be arranged so that each oscillating heat pipe has a portion that is proximal to a wall member defining an external surface of the stator.

The stator may be a stator vane. The oscillating heat pipes may be arranged at a leading edge of the vane. A trailing edge of the vane may be free from oscillating heat pipes. For example, a rear half of the vane may be free from oscillating heat pipes.

A plurality of oscillating heat pipes may be arranged proximal to a suction surface of the vane. A plurality of oscillating heat pipes may be arranged proximal to a pressure surface of the vane. For example, a portion of each oscillating heat pipe proximal to the suction surface may be adjacent a section of the stator defining the gas washed suction surface of the stator vane, and a portion of each oscillating heat pipe proximal to the pressure surface may be adjacent a section of the stator defining the gas washed pressure surface of the stator vane.

The vane may comprise a first oscillating heat pipe having a portion proximal to a gas washed surface of the vane (e.g. a pressure surface or a suction surface of the vane). The vane may comprise a second oscillating heat pipe having a portion proximal to a gas washed surface of the vane (e.g. a pressure surface or a suction surface of the vane). The portion of the first oscillating heat pipe proximal to the gas washed surface may be nearer the heat source than the portion of the second oscillating heat pipe proximal to the gas washed surface. The first oscillating heat pipe may have a base portion and the second oscillating heat pipe may have a base portion. The base portion of the first oscillating heat pipe may be nearer the gas washed surface than the base portion of the second oscillating heat pipe.

Further optionally, the vane may comprise a third oscillating heat pipe having a portion proximal to a gas washed surface of the vane (e.g. a pressure surface or a suction surface of the vane). The portions of the first and second oscillating heat pipes proximal to the gas washed surface may be nearer the heat source than the portion of the third oscillating heat pipe proximal to the gas washed surface. The third oscillating heat pipe may have a base portion. The base portions of the first and second oscillating heat pipes may be nearer the gas washed surface than the base portion of the third oscillating heat pipe.

Insulation may be provided between the oscillating heat pipes. E.g. the laminate may be defined by alternating layers of oscillating heat pipe and insulation.

The insulation may be made from a plastic material, carbon epoxy, or a carbon bismaleimide

Heat conducting spacers may be provided between the oscillating heat pipes at a position proximal to a heat source for the oscillating heat pipes. For example, at a position proximal to a base of the stator. The heat conducting spacers may be for example metal shims.

The stator may be injection moulded. The stator may define region for housing the oscillating heat pipes. For example, the stator may be plastic injection moulded. The plastic injection moulded stator may define insulation between the oscillating heat pipes.

A heat source for the oscillating heat pipes may be provided proximal to one end of the stator.

Fins may project into the heat source in a region proximal to the stator for improving transfer of heat from the heat source to the oscillating heat pipes.

The stator may be positioned in a recess defined by a casing member. A heat conductive material, for example a metallic material, may be provided in said recess. For example, the heat conductive material may surround a portion of the stator vane provided in the recess. The conductive material may be a metallic paste or braised potting. In such an example, fins may project from a base and/or sides of the recess into the heat source.

An end of the stator opposite the recess may be rigidly connected to a further casing member.

The stator may have a tapered end adjacent the further casing member. The stator may be fixed relative to the casing member using one or more wedges adjacent the tapered end. The wedge and the tapered end may be arranged to have complimentary contact surfaces. The tapered end of the stator may taper outwardly and the wedge may taper inwardly. The one or more wedges may have an elastomeric coating, for example a rubber coating. The one or more wedges may be connected to the casing member, using for example one or more fasteners, e.g. bolts. The casing member may define the one or more wedges.

When the stator is an engine section stator vane, a plurality of said vanes may be provided. A plurality of wedges may be provided between the vanes. In exemplary embodiments, a splitter ring of the gas turbine engine may define the wedges.

A heat source for the oscillating heat pipes may be oil from a gearbox of the gas turbine engine. For example, the gear box may have an oil manifold. The manifold may be thermally connected to the oscillating heat pipes.

In exemplary embodiments, recesses may be provided in a casing member and the recesses may protrude into the manifold. Fins may protrude from the recess into the manifold.

The stator may be a vane. The stator may be an engine section stator vane.

The stator may be coated with a nanocrystalline metallic coating. The nanocrystalline metallic coating may define a gas washed surface of the stator.

In an aspect there is provided a component comprising a plurality of laminated oscillating heat pipes.

The oscillating heat pipes may be of varying lengths.

A portion of each oscillating heat pipe may be aligned with a portion of at least one other oscillating heat pipe.

A portion of an oscillating heat pipe may insulate a portion of an adjacent oscillating heat pipe.

In a further aspect there is provided a gas turbine engine comprising a plurality of engine section stators and a gearbox having an oil manifold. The engine section stators comprise a plurality of oscillating heat pipes. The oscillating heat pipes and oil manifold are arranged such that oil in the manifold is a heat source for the oscillating heat pipes.

The oscillating heat pipes may be arranged so as to output heat from the engine section stator so as to limit ice formation on the engine section stator.

In a yet further aspect there is provided a gas turbine engine comprising a plurality of engine section stators having a plastic body.

For example, the engine section stators may be plastic injection moulded.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a schematic sectional side view of a gas turbine engine;

FIG. 2 is a schematic partial sectional side view of a gas turbine engine;

FIG. 3 is a schematic of an oscillating heat pipe;

FIG. 4 is a schematic cross section through an engine section stator vane;

FIG. 5 is a schematic side view of an engine section stator vane;

FIG. 6 is a schematic partial cross section through a manifold and engine section stator vanes;

FIG. 7 is a schematic view of a joint region between the manifold and an engine section stator vane;

FIG. 8 is a schematic front view of a connection between an engine section stator vane and a casing member;

FIG. 9 is a schematic partial side view of an engine section stator vane connected to a casing member;

FIG. 10 is a schematic partial side view of an alternative connection between an engine section stator vane and a casing member;

FIG. 11 is a schematic plan view of splitter ring fingers provided between engine section stator vanes;

FIG. 12 is a schematic front view of the alternative connection of between the engine section stator vanes and the casing member of FIGS. 10 and 11; and

FIG. 13 is a schematic partial cross section through an engine section stator vane.

### DETAILED DESCRIPTION

With reference to FIG. 1, a gas turbine engine is generally indicated at 10, having a principal and rotational axis 11. The engine 10 comprises, in axial flow series, an air intake 12, a propulsive fan 13, a gearbox 14, an intermediate pressure compressor 15, a high-pressure compressor 16, combustion equipment 17, a high-pressure turbine 18, a low-pressure turbine 19 and an exhaust nozzle 20. A fan case 21 defines the intake 12.

The gas turbine engine 10 works in the conventional manner so that air entering the intake 12 is accelerated by the fan 13 to produce two air flows: a first air flow into the intermediate pressure compressor 15 and a second air flow which passes through a bypass duct 22 to provide propulsive thrust. The intermediate pressure compressor 15 compresses the air flow directed into it before delivering that air to the high pressure compressor 16 where further compression takes place.

The compressed air exhausted from the high-pressure compressor 16 is directed into the combustion equipment 17 where it is mixed with fuel and the mixture combusted. The resultant hot combustion products then expand through, and thereby drive the high 18 and low-pressure 19 turbines before being exhausted through the nozzle 20 to provide additional propulsive thrust. The high 18 and low 19 pressure turbines drive respectively the high pressure compressor 16 and intermediate pressure compressor 15, each by suitable interconnecting shaft. The low pressure shaft also drives the fan 13 via the gearbox 14. The gearbox 14 is a reduction gearbox in that it gears down the rate of rotation of the fan 13 by comparison with the intermediate pressure compressor 15 and low pressure turbine 19. The gearbox 14 is an epicyclic planetary gearbox having a static ring gear, rotating and orbiting planet gears supported by a planet carrier and a rotating sun gear.

Other gas turbine engines to which the present disclosure may be applied may have alternative configurations. By way of example the gearbox may be a star gearbox rather than an epicyclic planetary gearbox. Additionally or alternatively the gearbox may drive additional and/or alternative components (e.g. the intermediate pressure compressor and/or a booster compressor). The gearbox may even be omitted altogether. Additionally or alternatively such engines may have an alternative number of compressors and/or turbines and/or an alternative number of interconnecting shafts.

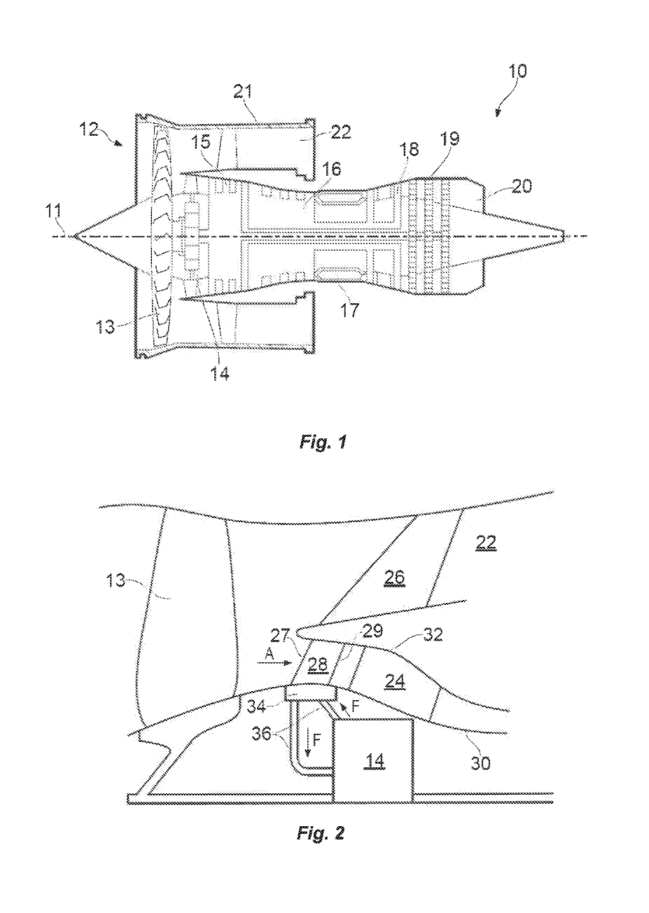

Referring to FIG. 2, air flow entering the bypass duct 22 is guided by inlet guide vanes 26, and air flow entering the core is guided by engine section stator (ESS) vanes 28. The ESS vanes and a strut 24 extend between an inner casing member 30 and an outer casing member 32. In the present example, the strut 24 is structural but the ESS vanes are non-structural. A plurality of ESS vanes are spaced circumferentially around the entrance to the core. The ESS vanes have a leading edge 27 and a trailing edge 29, and have an aerofoil profile. The aerofoil profile has a suction surface extending from the leading edge to the trailing edge and a pressure surface extending from the leading edge to the trailing edge.

The gearbox 14 is associated with a manifold 34 connected to the gearbox by pipes 36. Oil from the gearbox circulates to the manifold as indicated by arrows F. During operation of the gas turbine engine the oil of the gearbox will be elevated in temperature.

As discussed previously, the ESS vanes are non-structural. The ESS vanes are also thin. However, due to the lower speed of the fan and the high number of vanes, ice formation on the vanes is potentially a bigger problem than in other engine designs. As such, in the present example, oscillating heat pipes (OHPs) are provided in the ESS vanes so as to reduce or eliminate ice build-up on the vanes. OHPs may also be referred to as pulsating heat pipes (PHPs). Oil from the gearbox 14, in this example oil in the manifold 34, provides a heat source for the OHPs.

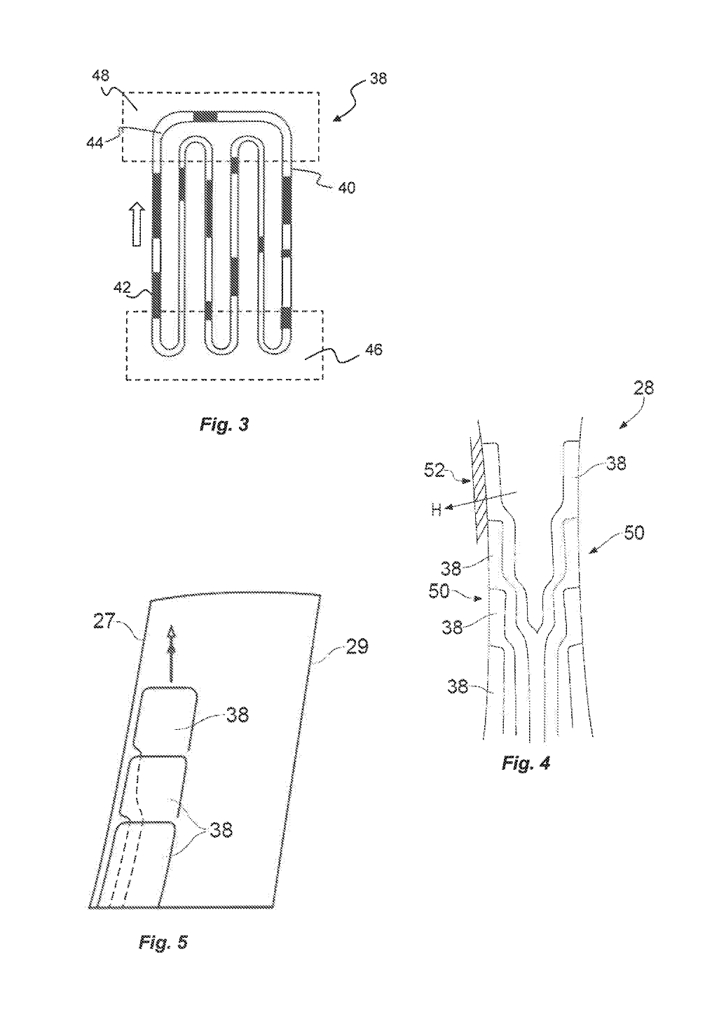

Referring to FIG. 3, an example of a closed loop OHP 38 is illustrated. The OHP includes a pipe 40 of capillary dimension. The pipe oscillates so as to define a series of U-turns. A bi-phase fluid is provided in the pipes such that liquid slugs 42 and vapour plugs 44 flow through the pipes. In this example, the fluid is any one or any combination of glycol, water, alcohol, and/or refrigerant. The pipe oscillates between an evaporator 46 and a condenser 48. The evaporator is a heat source and the condenser is where heat is rejected from the OHP. A differential pressure between the evaporator and condenser, due to a temperature difference, drives the fluid through the pipe oscillating between the evaporator and the condenser. Construction of oscillating heat pipes is well documented in the literature at the time of filing this application, and as such it will not be discussed in more detail here.

Referring now to FIGS. 4 and 5, the arrangement of the OHPs 38 in the ESS vanes 28 will be described in more detail. The OHPs are arranged proximal to the leading edge 27. In the present example, the trailing edge is free from OHPs, indeed the OHPs are concentrated in the forward-most section of the ESS (direction being defined with respect to the principal axial air flow through the gas turbine engine). The OHPs are arranged in this way because ice formation is primarily an issue on the leading edge of the ESS.

The OHPs 38 are laminated. That is, the OHPs are stacked or arranged adjacent to each other. The OHPs are provided on a carrier medium, e.g. a metallic carrier medium, which permits the OHPs to be easily stacked. The OHPs are arranged so as to stack towards the outer walls 50 of the ESS vane 28 at the leading edge of the blade. That is, the OHPs are arranged towards the leading edge region of the pressure surface and the suction surface of the ESS vane.

The OHPs are stacked such that a portion of each OHP is arranged to be substantially aligned with (or coaxial with) a portion of at least one or more of the other OHPs. In this way, all OHPs at the suction side have a portion aligned with a portion of the other OHPs at the suction side, and all the OHPs at the pressure side have a portion aligned with a portion of the OHPs at the pressure side. Such an arrangement means that the condenser of each OHP can be arranged to be proximal to the outer wall 50 of the ESS vane. Further, the OHP heating a portion of the vane at a greatest distance from the heat source can be provided more towards a centre of the vane so that the OHP is insulated where needed, and heat rejection can be limited in areas other than where it is needed. In this way, the outer surface of the leading edge of the ESS can be heated more effectively across the vane span (e.g. the entire vane span) so as to dissuade ice formation and build-up.

In the present example, the OHPs are bonded or braised together. The OHPs may be brazed together at selected points to define an OHP sub-assembly. The OHP sub-assembly may be placed in a mould and a plastic insulting matrix may fill any gaps between adjacent OHPs. Alternatively, a dry fabric layup could be integrated with a sub-assembly of spaced OHPs and a resin transfer moulding process may be used to inject resin to the dry fabric lay-up.

The number of OHPs 38 provided will be dictated by the heat transfer requirements and the thickness of the ESS vane 28.

A nanocrystalline metallic coating 50 may be provided. The coating defines the gas washed surface of the ESS vane. That is, the nanocrystalline metallic coating is provided on the leading edge, trailing edge, suction surface and pressure surface of the ESS vane. However, in alternative examples the nanocrystalline coating may only be provided on the leading edge, and a region of the suction surface and pressure surface proximal to the leading edge, for example, only where the OHPs are provided. Nanocrystalline metallic coatings have good heat transfer properties, so can further contribute to the reduction of ice build-up on the ESS vane, whilst providing good surface finish for efficiency and erosion protection.

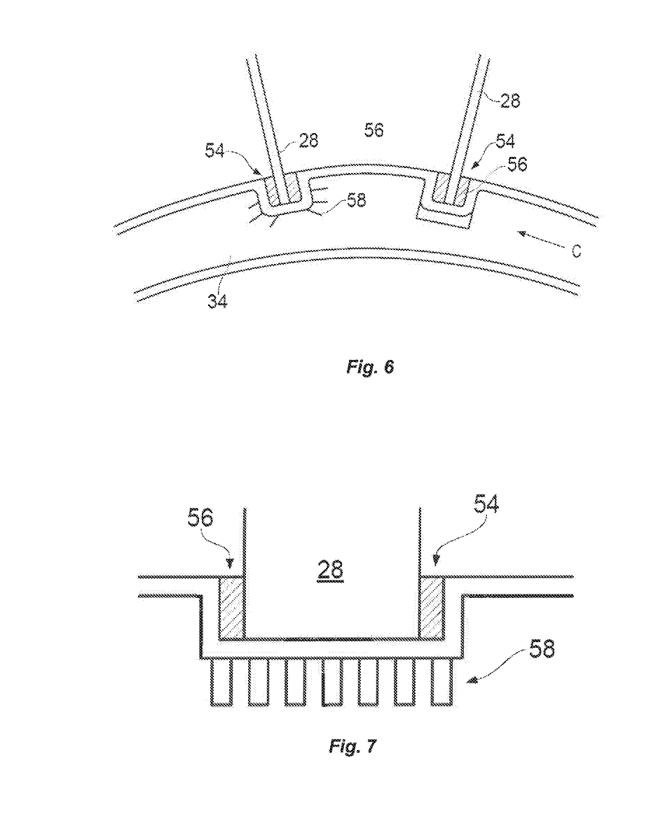

Referring now to FIGS. 6 and 7, connection of the ESS vanes to the manifold 34 will now be described in more detail. The manifold includes a plurality of recesses 54 spaced circumferentially around a radially outer surface of the manifold. Each recess 54 is dimensioned and shaped to receive a base of one of the ESS vanes. The recess is filled with a filler 56, e.g. a metallic filler such as a metallic paste and/or a braised potting. In this way, a portion of the ESS vane in the recess is surrounded by the filler.

Fins 58 are provided. The fins 58 protrude from a base of the recess 54 into the manifold 34. In this case, the fins 58 are provided along the base and the sides of the recess, or only along the base. The fins may extend the full axial length of the recess. The fins may be metallic fins. Provision of the fins improves heat transfer from the oil in the oil manifold to the OHPs 38 of the ESS vane 28.

The ESS vanes 28 are rigidly connected to the gas turbine engine at an opposite end to the manifold 34. It will be appreciated that the ESS vanes can be connected using various different methods, but an example of two methods will be now described.

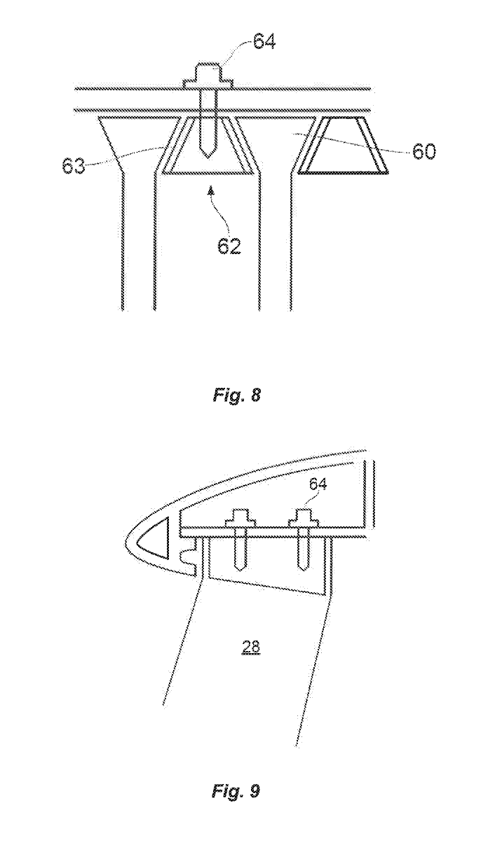

Referring to FIGS. 8 and 9, the ESS vane 28 may have a tapered end 60 (i.e. a tapered radially outer end). The tapering of the vane is outward toward the outer casing member so that the ESS vane is wider at a position more radially outward than at a position more radially inward. Wedges 62 are provided between the tapered ends 60. The wedges taper inwardly towards the outer casing member. The wedges 62 clamp the tapered ends, and therefore the ESS vanes to an outer casing member. In the present example, the wedges 62 include an elastomeric covering 63, e.g. a rubber cover. The wedges 62 are held in position by one or more fasteners 64. The fasteners extend through the outer casing member and into the wedge 62. The fasteners extend from a radially outer surface of the casing member so as to avoid the gas washed surface (i.e. the surface washed by flow entering the core).

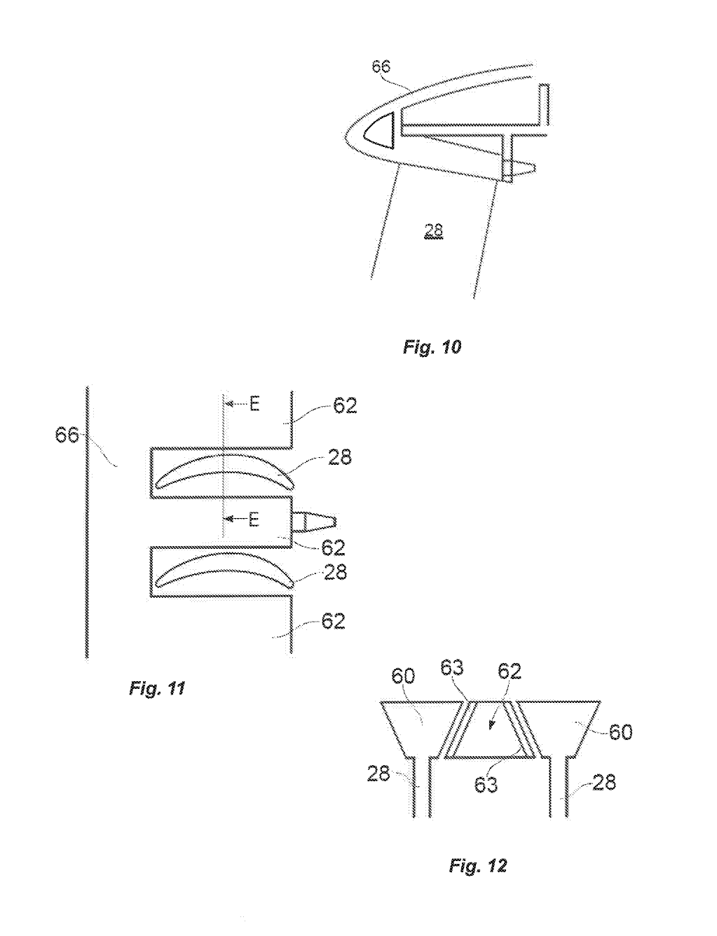

Referring to FIGS. 10 to 12, in alternative embodiments the wedges 62 may be integrally formed with the splitter ring 66. The splitter ring may define axially extending fingers that form the wedges 62. In such an example, fasteners 64 are not required.

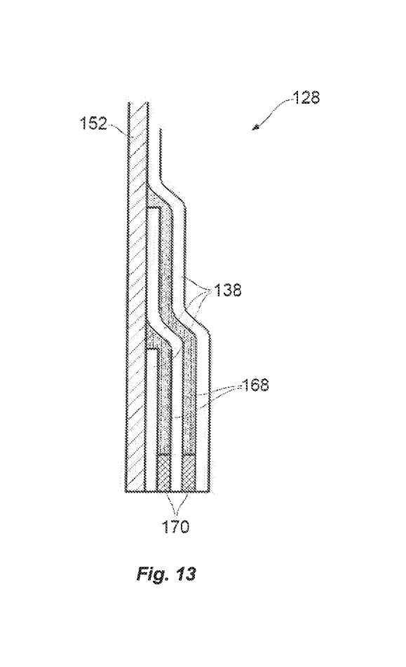

An alternative ESS vane arrangement will now be described with reference to FIG. 13. Similar reference numerals are used as previously used, but with a prefix “1” to distinguish between embodiments.

The ESS vane 128 is defined by a plastic injection moulded structure 168. OHPs 138 are provided between dividing structures defined by the plastic injection moulded structure. The dividing structures can provide insulation between the OHPs in the regions where the OHPs overlap. Similar to the previously described example, the OHPs and the dividing structures are arranged such that the OHPs each have a section that is aligned with the other OHPs in a respective region at a position proximal to an outer wall. Heat conducting spacers 170 may be provided at the base of the ESS vane to aid heat transfer from oil in the manifold to the OHPs.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, the laminar arrangement of oscillating heat pipes may be provided on other stator vanes of a gas turbine engine, with the heat source being oil from a gearbox, or an alternative source, for example high temperature air at one or more positions of the gas turbine engine (e.g. bled from the compressor). The oscillating heat pipes may also be used in other applications where de-icing is required, for example the described arrangement of heat pipes may be used on a ship's hull to distribute heat effectively to control external growth of the hull.

1. A gas turbine engine comprising a stator, wherein the stator comprises laminated oscillating heat pipes, and
wherein one or more of the oscillating heat pipes have a first portion and a second portion extending in a spanwise direction of the stator and a transition region connecting the first portion to the second portion, wherein the first portion extends in a different plane to the second portion, and the oscillating heat pipes are of varying lengths, and a portion of each oscillating heat pipe is aligned with a portion of at least one other oscillating heat pipe.

2. The gas turbine engine according to claim 1, wherein the stator is an engine section stator.

3. The engine according to claim 1, wherein the stator is a stator vane, and wherein the oscillating heat pipes are arranged at a leading edge of the vane.

4. The engine according to claim 3, wherein a plurality of oscillating heat pipes are arranged proximal to a suction surface of the vane and a plurality of oscillating heat pipes are arranged proximal to a pressure surface of the vane.

5. The engine according to claim 1, wherein insulation is provided between the oscillating heat pipes.

6. The engine according to claim 5, wherein the insulation is made from a plastic material, carbon epoxy, or a carbon bismaleimide.

7. The engine according to claim 1, wherein heat conducting spacers are provided between the oscillating heat pipes at a position proximal to a heat source for the oscillating heat pipes.

8. The engine according to claim 1, wherein the stator is injection moulded and defines regions for housing the oscillating heat pipes.

9. The engine according to claim 1, wherein a heat source for the oscillating heat pipes is provided proximal to one end of the stator and wherein fins project into the heat source in a region proximal to the stator for improving transfer of heat from the heat source to the oscillating heat pipes.

10. The engine according to claim 1, wherein the stator is positioned in a recess defined by a casing member, and a heat conductive material, for example a metallic material, is provided in said recess.

11. The engine according to claim 10, wherein an end of the stator opposite the recess is rigidly connected to a further casing member.

12. The engine according to claim 1, wherein a heat source for the oscillating heat pipes is oil from a gearbox of the gas turbine engine.

13. The engine according to claim 1, wherein the stator is an engine section stator vane.

14. The engine according to claim 1, wherein the stator is coated with a nanocrystalline metallic coating.

15. The engine according to claim 1, wherein the stator is an engine section stator and the engine comprises a plurality of said engine section stators; and a gearbox having an oil manifold; wherein the oil manifold is arranged such that the oil in the manifold is a heat source for the oscillating heat pipes.

16. A component comprising a plurality of laminated oscillating heat pipes, the oscillating heat pipes being of varying lengths, and wherein a portion of each oscillating heat pipe is aligned with a portion of at least one other oscillating heat pipe.

17. A gas turbine engine comprising a stator, wherein the stator comprises laminated oscillating heat pipes.

18. The gas turbine engine according to claim 17, wherein one or more of the oscillating heat pipes have a first portion and a second portion extending in a spanwise direction of the stator and a transition region connecting the first portion to the second portion, wherein the first portion extends in a different plane to the second portion.

19. The engine according to claim 17, wherein the oscillating heat pipes are of varying lengths, and wherein a portion of each oscillating heat pipe is aligned with a portion of at least one other oscillating heat pipe.
